(19) United States
(12) Patent Application Publication
(10) Pub. No.: US 2011/0079364 A1
(43) Pub. Date: Apr. 7, 2011

(54) Process for Controlling Ammonia Loss

(75) Inventors: Thomas Frank Stroup, Brevard, NC (US); David Michael Goodman, Waverly, TN (US); Robert Edward Stone, Austin, TX (US)

(73) Assignee: TIN INC., D/B/A TEMPLE-INLAND, Diboll, TX (US)

(21) Appl. No.: 12/573,749

(22) Filed: Oct. 5, 2009

(51) Int. Cl. D21C 11/12; D21C 11/06; B01D 53/48

(52) U.S. Cl. 162/29; 423/244.07; 423/244.08; 423/242.1

(57) ABSTRACT

A method of offsetting losses of ammonia from a pulping mill comprising cooking a lignocellulosic material in a cooking liquor, wherein cooking in the cooking liquor separates the lignocellulosic material into a pulp, capturing a vapor of the cooking liquor, condensing the vapor of the cooking liquor to yield a spent cooking liquor condensate, washing the pulp in a wash liquid, wherein washing the pulp removes at least a portion of the spent cooking liquor from the pulp, capturing the wash liquid, removing ammonia from the wash liquid to yield a regenerated ammonia, regenerating the cooking liquor from the spent cooking liquor condensate and the regenerated ammonia, combusting a waste material and a concentrated spent cooking liquor, wherein combusting the waste material and the concentrated spent cooking liquor yields a flue gas and heat, transferring the heat from combusting the waste material and the concentrated spent cooking liquor to water to generate steam, removing a sulfur-containing compound from the flue gas, and introducing an effluent stream into an effluent treatment system, wherein introduction of the effluent stream into the effluent system will remove ammonia from the effluent stream.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Pulping is the process of converting wood or other lignocellulosic material into separated fibers, that is, pulp which is commonly used in the papermaking process. The production of pulp may be accomplished by several known processes, examples of which include purely mechanical processes, thermomechanical processes, chemithermomechanical processes, chemimechanical processes, and purely chemical processes.

One suitable pulping process is the sulfite process. The sulfite process produces pulp using various salts of sulfurous acid to degrade the lignin in wood chips in large pressure vessels known in the art as digesters. The sulfite process utilizes heat and the chemicals break down the lignin, which binds the cellulose fibers together, without seriously degrading the cellulose fibers. Generally, the salts used in the sulfite pulping process are either sulfites (SO₃²⁻), bisulfites (HSO₃⁻), or combinations thereof. The term ammonium sulfite process is generally recognized by those of skill in the art to include both ammonium sulfites and ammonium bisulfites since both occur in the process in amounts and percentages, dependent upon the pH in various process stages. The counter ion is generally selected from a group comprising sodium (Na⁺), calcium (Ca²⁺), potassium (K⁺), magnesium (Mg²⁺), or ammonium (NH₄⁺).

Pulping via an ammonium sulfite process thus requires inputs of sulfur and ammonia. At least a portion of the sulfur utilized in the process has conventionally been recovered and reused in the process or otherwise recycled. The ammonia utilized in the process, however, has conventionally been lost to the process, either because it is destroyed (e.g., via combustion), unrecovered from the pulp, or lost to one or more effluent streams. Thus, conventionally, it has been necessary to continually incorporate fresh ammonia into the process.

### SUMMARY

In an embodiment, a method of offsetting losses of ammonia from a pulping mill disclosed herein comprises cooking a lignocellulosic material in a cooking liquor, wherein cooking in the cooking liquor separates the lignocellulosic material into a pulp. The method may further comprise capturing a vapor of the cooking liquor, condensing the vapor of the cooking liquor to yield a spent cooking liquor condensate and washing the pulp in a wash liquid, wherein washing the pulp removes at least a portion of the spent cooking liquor from the pulp. The method may further comprise capturing the wash liquid, removing ammonia from the wash liquid to yield a regenerated ammonia, regenerating the cooking liquor from the spent cooking liquor condensate and the regenerated ammonia, and combusting a waste material and a concentrated spent cooking liquor, wherein combusting the waste material and the concentrated spent cooking liquor yields a flue gas and heat. The method may further comprise transferring the heat from combusting the waste material and the concentrated spent cooking liquor to water to generate steam, removing a sulfur-containing compound from the flue gas, and introducing an effluent stream into an effluent treatment system, wherein introduction of the effluent stream into the effluent system will remove ammonia from the effluent stream.

In an embodiment, a method of recovering ammonia from a pulping process disclosed herein comprises washing a pulp in a wash liquid, capturing the wash liquid, evaporating a portion of the wash liquid to yield a vaporous mixture of water and ammonia, condensing the vaporous mixture of water and ammonia to yield an evaporator condensate, raising the pH of the evaporator condensate; and separating the ammonia from the evaporator condensate to yield a regenerated ammonia.

In an embodiment, a method of controlling the occurrence of a sulfur-containing compound in a waste-fuel boiler flue gas disclosed herein comprises introducing a waste material and a concentrated spent cooking liquor into the waste-fuel boiler, contacting magnesium oxide with the concentrated spent cooking liquor, combusting the waste material and the concentrated spent cooking liquor, wherein combusting the waste material and the concentrated spent cooking liquor yields the flue gas, and contacting a base compound with the flue gas.

### BRIEF DESCRIPTION OF THE DRAWINGS

FIG. 1 is a schematic illustration of an embodiment of an ammonia loss control process.

FIG. 2 is a partial cutaway of an embodiment of a steam stripper.

### DETAILED DESCRIPTION

### Notation and Nomenclature

It should be understood at the outset that although illustrative implementations of one or more embodiments are illustrated below, the disclosed systems and methods may be implemented using any number of techniques, whether currently known or in existence. The disclosure should in no way be limited to the illustrative implementations, drawings, and techniques illustrated below, but may be modified within the scope of the appended claims along with their full scope of equivalents.

Unless otherwise specified, use herein of the term “ammonia” shall include both ionic and non-ionic forms, that is, both ammonia (NH₃) and ammonium (NH₄). In various embodiments of an ammonia loss control process disclosed herein, ammonia comprising one or more of the fluids or gases disclosed herein may be free or may be chemically bound. Generally, free ammonia refers to NH₃ which may be easily volatilized from aqueous solution while bound ammonia generally refers to ionic NH₄⁺ which is generally more difficult or impractical to volatilize.

### General Overview of Ammonia Loss Control Process

The processes and systems disclosed herein improve upon conventional processes and systems of sulfite pulping. Disclosed herein are one or more embodiments of processes and systems that may be employed to control ammonia losses from an ammonium sulfite pulping process. In at least one embodiment which will be described herein, the processes and systems may comprise recapturing ammonia from a pulping process effluent stream. The ammonia recaptured may be regenerated to form a pulping process input and/or reintroduced into the pulping process. As such, at least a portion of the ammonia which has been lost in conventional ammonium sulfite pulping processes can be reused, thereby reducing capital and/or operating expenditures related to a sulfite pulping process. Further, ammonia losses to the environment as a part of an effluent stream of such conventional processes may give rise to environmental and/or regulatory concerns. As such, implementing one or more of the methods or systems disclosed herein may advantageously reduce ammonia emissions to address such concerns.

In another embodiment disclosed herein, the recovery of ammonia from an ammonium sulfite pulping process effluent stream is improved over conventional methods by adjusting the pH of an ammonia containing stream and thereby increasing the amount of ammonia which may be recovered. In still another embodiment disclosed herein, ammonia losses are mitigated by employing alternative compounds as process inputs where ammonia had conventionally been employed as a process input.

Generally speaking, in the process disclosed herein a lignocellulosic material may be cooked in a cooking liquor within a digester to separate the lignocellulosic material into a pulp. As the lignocellulosic material is cooked, at least a portion of the cooking liquor evaporates and may be captured and condensed to yield a digester condensate. The digester condensate may be used to regenerate cooking liquor which may be reused in the process. As such, at least a portion of the ammonia utilized in the process may be captured and reused in the process.

Ammonia is also recovered by washing spent cooking liquor from the pulp. A portion of the ammonia comprising the spent cooking liquor may be evaporated from the spent cooking liquor and condensed. The pH of the condensate may be elevated prior to introduction into a steam stripper where steam may be used to volatilize and thereby separate ammonia from other components of the condensate, thus yielding regenerated ammonia which may be reused in the process.

As some portion of ammonia is evaporated from the spent cooking liquor, a concentrated spent cooking liquor remains. The concentrated spent cooking liquor and process waste materials may be burned to create heat to generate steam which may be used to provide heat to various pulping process operations. The occurrence of potentially harmful sulfur-containing compounds in the resulting flue gas may be limited by introducing magnesium oxide into the concentrated spent cooking liquor prior to combustion and by “scrubbing” the flue gas with a solution having a basic pH. Additionally, ammonia may be removed from one or more effluent streams from a pulping process by introduction into an effluent treatment system.

### Digesting Wood

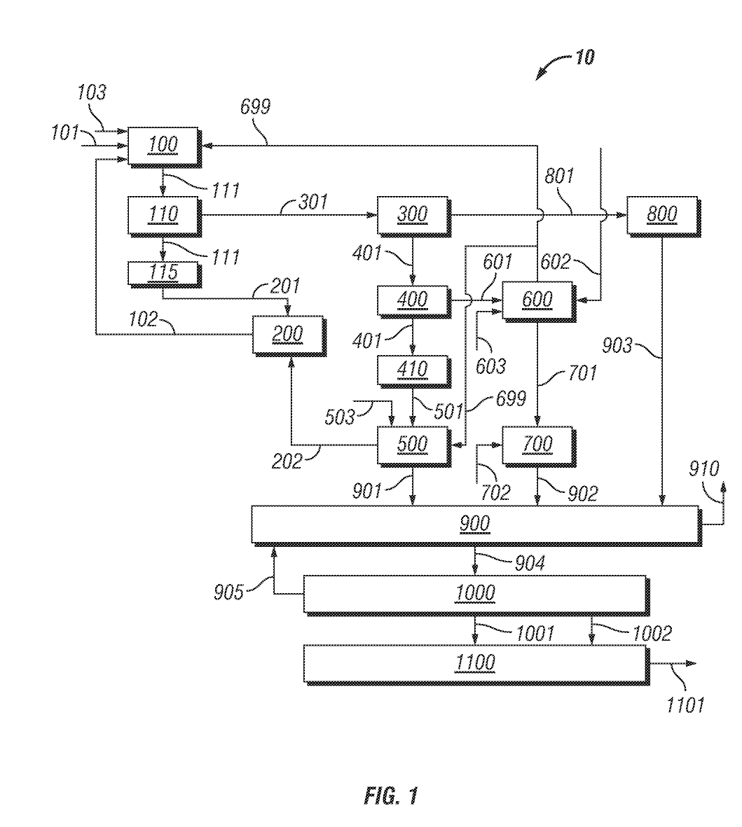

Referring to FIG. 1, the ammonia loss control process 10 is represented schematically. In the embodiment of FIG. 1, the ammonia loss control process 10 comprises feeding a lignocellulosic material 101 into a digester 100. In this embodiment, the lignocellulosic material 101 comprises wood chips. Alternatively, in embodiments, a lignocellulosic material may comprise a non-woody lignocellulosic material for which pulping is desired. In the ammonia loss control process 10, a cooking liquor 102 is also fed into the digester 100. Anhydrous ammonia 103 may also be added to the process at this point for pH control. The wood chips are cooked in the cooking liquor 102 within the digester 100. In the ammonia loss control process 10, the digester 100 receives heat energy in the form of steam 699 from the waste fuel boiler 600.

In embodiments, the wood chips are cooked in the cooking liquor 102, thereby degrading the lignin bonds which hold the wood fibers together. In this embodiment, the wood chips are cooked in the cooking liquor 102 for a period of time ranging from about 10 to about 20 minutes. In alternative embodiments, the wood chips may be cooked for a period of time ranging from about 5 minutes to about 1 hour, alternatively, from about 1 to about 8 hours. The temperature within the digester 100 ranges from about 250° F. to about 375° F., alternatively, from about 275° F. to about 350° F., alternatively, from about 290° F. to about 310° F. In this embodiment, the pressure within the digester 100 ranges from about 20 P.S.I. to about 75 P.S.I.

In the embodiment of FIG. 1, the cooking liquor 102 comprises a salt. In the embodiment of FIG. 1, the salt comprises ammonium sulfite ((NH₄)₂SO₃). Alternatively, a cooking liquor salt may comprise ammonium bisulfite (NH₄HSO₃), other suitable ammonium salts, or combinations thereof, such other suitable salts being familiar to those of skill in the art. Although this disclosure focuses on ammonium sulfite ((NH₄)₂SO₃), one of skill in the art will appreciate that a cooking liquor comprising ammonium bisulfite (NH₄HSO₃) or combinations of ammonium sulfite ((NH₄)₂SO₃) and ammonium bisulfite (NH₄HSO₃) may be employed with respect to one or more of the embodiments disclosed herein. For example, the salt may comprise a salt suitably employed in a neutral sulfite semi-chemical (NSSC) process, an acid sulfite processes, an acid bisulfite process, an alkaline sulfite process, or combinations thereof. During the cooking process, the ammonium sulfite ((NH₄)₂SO₃) reacts with the lignin in the wood chips, thereby cleaving the lignin bonds which bind the individual wood fibers together. Cleavage of the lignin bonds causes the wood chips to disintegrate into individualized fibers, thereby yielding wood pulp. In alternative embodiments, a mechanical device (e.g., a stirrer, blender or defibrator) may be employed to aid in disintegrating the wood chips.

### Capturing Digester Condensate

In embodiments, the ammonia loss control process 10 comprises capturing a gaseous digester effluent 111. As shown in FIG. 1, the gaseous digester effluent 111 exits the digester 100. The gaseous digester effluent 111 comprises water vapor and volatilized ammonia. In embodiments, the gaseous digester effluent 111 is fed into a digester blow tank 110 and/or directly to a cooling device 115. In the digester blow tank 110 the water vapor and volatilized ammonia are directed to the cooling device 115 where the gaseous digester effluent 111 may condense to form a digester condensate 201. The digester condensate 201 comprises ammonia.

### Regenerating Cooking Liquor

In embodiments, the ammonia loss control process 10 comprises regenerating the cooking liquor 102. As shown in FIG. 1, the ammonia loss control process 10 comprises introducing the digester condensate 201 and a stream of regenerated ammonia 202 from a steam stripper 500, which will be discussed herein below, into a cooking liquor generation system 200. Upon introduction of the digester condensate 201 and the regenerated ammonia 202, the ammonia loss control process 10 further comprises regenerating the cooking liquor 102 in the cooking liquor generation system 200.

In embodiments, regenerating the cooking liquor 102 comprises a sequence of reactions in which the ammonia in the digester condensate 201 and the regenerated ammonia stream 202 are combined with sulfur or a sulfur-containing compound to yield ammonium sulfite ((NH₄)₂SO₃) and/or ammonium bisulfite (NH₄HSO₃). In embodiments, the sequence of reactions may comprise contacting sulfur (S) with oxygen (O₂) under suitable conditions to yield sulfur dioxide (SO₂) as demonstrated in Equation (I). The sulfur dioxide (SO₂) is then contact with water (H₂O) under suitable conditions to yield sulfurous acid (H₂SO₃) as demonstrated in Equation (II).

S+O₂→SO₂ Equation (I)

SO₂+H₂O→H₂SO₃ Equation (II)

The sequence of reactions further comprises reaction of the ammonium (NH₄⁺) counter ion with the sulfurous acid (H₂SO₃) to yield ammonia sulfite ((NH₄)₂SO₃), ammonium bisulfite ((NH4)HSO3), or combinations thereof. The ammonium (NH₄) counter ion is introduced as ammonium hydroxide (NH₄OH) as demonstrated in equation (III) and equation (IV).

2NH₄OH+H₂SO₃→(NH₄)₂SO₃+2H₂O Equation (III)

NH₄OH+H₂SO₃→(NH₄)HSO₃+H₂O Equation (IV)

In the embodiment of FIG. 1, the ammonia loss control process 10 comprises expelling the regenerated cooking liquor 102 from the cooking liquor generation system 200 and, as discussed above, introducing the regenerated cooking liquor 102 into the digester 100.

Conventionally, digester effluent has not been captured and, as such, the ammonia in the digester effluent has been lost. Thus, by capturing, condensing, and reintroducing ammonia from the digester effluent 111, the ammonia loss control process 10 controls or manages at least a portion of the ammonia losses conventionally associated with an ammonium sulfite pulping process.

### Washing the Pulp

In embodiments, the ammonia loss control process 10 comprises washing the pulp 301. As shown in FIG. 1, the ammonia loss control process 10 comprises introducing the pulp 301 extruded from the digester 100 into a pulp washer 300. Having previously been cooked in cooking liquor 102 within the digester 100, the pulp 301 extruded from the digester 100 will comprise spent cooking liquor. Washing the pulp 301 separates at least a portion of the spent cooking liquor from the pulp 301 and removes other impurities, such as dissolved wood material.

In the embodiment of FIG. 1, washing the pulp 301 comprises spraying the pulp 301 extruded from the digester 100 with water emitted from one or more water jets within the pulp washer 300. As the pulp 301 moves through the pulp washer 300, water is sprayed onto the pulp 301, thereby removing cooking liquor and dissolved wood material from the pulp 301. In alternative embodiments, pulp may be sprayed with various other wash fluids which will be known to those of skill in the art. In still other alternative embodiments, washing the pulp may comprise introducing the pulp to one or more solvent baths, for example, a water bath.

### Capturing the Wash Water

In embodiments, the ammonia loss control process 10 comprises capturing the water used to wash the pulp. The wash water comprises a dilute spent cooking liquor 401. The dilute spent cooking liquor 401 may also comprise dissolved or particulate wood material which has been washed out of the pulp.

### Concentrating the Dilute Spent Cooking Liquor and Condensing the Water Vapor and Volatilized Ammonia

In embodiments, the ammonia loss control process 10 comprises concentrating the dilute spent cooking liquor 401. In the embodiment of FIG. 1, the dilute spent cooking liquor 401 is introduced into an evaporator 400. In the evaporator 400, the dilute spent cooking liquor 401 is concentrated by evaporating at least a portion of the water comprising the dilute spent cooking liquor 401. Further, at least a portion of the ammonia comprising the dilute spent cooking liquor 401 is volatilized in the evaporator.

In an embodiment, the evaporator 400 comprises one or more evaporator bodies. The one or bodies may be operated at different pressures in order to lower the boiling point of a liquid contained within a given body as compared to another body. Thus, not to be bound by theory, hotter vapor from a higher pressure body may provide the driving force to evaporate liquid in a lower pressure body. Temperatures may vary from about 310° F. to about 120° F. with pressures ranging from about 65 P.S.I. to about 10 P.S.I. The temperature within the evaporator 400 may be elevated to facilitate evaporation of the dilute spent cooking liquor. In embodiments, the temperature within the evaporator may be greater than about 75° F., alternatively, greater than about 100° F., alternatively, greater than about 125° F. Further, the pressure within the evaporator 400 may be less than ambient pressure so as to facilitate evaporation of the dilute spent cooking liquor 401. In embodiments, the pressure within the evaporator 400 may be less than about 101 kPa, alternatively, less than about 95 kPa, alternatively, less than about 90 kPa.

In the embodiment of FIG. 1, the ammonia loss control process 10 comprises condensing the volatilized dilute spent cooking liquor. The water vapor, volatilized ammonia and ammonia entrained as ammonia salts may be condensed and/or captured as condensate within the evaporator 400. An evaporator body effluent 411 (e.g., from one or more evaporator bodies) may be collected as condensates in a combined condensate in collection tank 410 and exit as a liquid evaporator effluent 501. In an alternative embodiment, the water vapor, volatilized ammonia and ammonia entrained as ammonia salts may exit an evaporator and be condensed to yield a liquid evaporator effluent. In embodiments, the evaporator condensate 501 comprises free ammonia, bound ammonia and water that may be contained in separate condensate streams or in one single combined condensate stream.

In the embodiment of FIG. 1, the dilute spent cooking liquor 401 comprises approximately 6-9% solids. In this embodiment, evaporation of the dilute spent cooking liquor 401 yields a concentrated spent cooking liquor 601 comprising from about 40% solids to about 60% solids, alternatively, about 50% solids.

Separating Ammonia from Water

In embodiments, the ammonia loss control process 10 comprises separating ammonia from the evaporator condensate 501. In the embodiment of FIG. 1, the evaporator condensate 501 is introduced into a steam stripper 500 where ammonia is separated from the evaporator condensate 501. In this embodiment, the evaporator condensate 501 is subjected to a steam stripping process. Not seeking to be bound by theory, steam stripping comprises separating components of a fluid via differences in boiling point or vapor pressure. In this embodiment, the ammonia comprising the evaporator condensate 501 is preferentially vaporized while the water comprising the evaporator condensate 501 is not; thus, the ammonia is separated from other components (e.g., water) of the evaporator condensate 501.

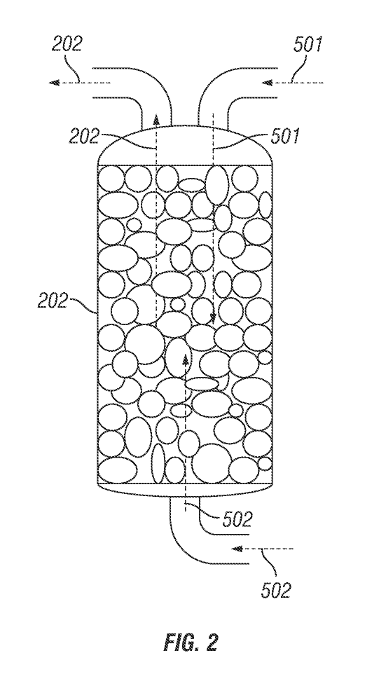

In embodiments, the steam stripper 500 of FIG. 1 comprises a packed column configured to provide a large surface area for contact between the evaporator condensate 501 and steam 699. In an alternative embodiment, a steam stripper may comprise any suitable stripper configuration. Turning to FIG. 2, in embodiments, the evaporator condensate 501 is introduced into the top of the steam stripper 500 and the steam 699 is introduced into the bottom of the steam stripper 500. As the evaporator condensate 501 moves generally downward through the packed column of the steam stripper 500, it comes into contact with steam 699 rising through the packed column of the steam stripper 500. Because the ammonia is more volatile than the other components of the evaporator condensate 501, e.g., water, the ammonia is volatilized and, thus, becomes vaporous. Thus, the introduction of the steam 699 elevates the temperature within the steam stripper 500 causing ammonia to be separated from the evaporator condensate 501. The ammonia exits the steam stripper 500 as ammonia 202 and the non-vaporized components of the evaporator condensate stream 501 exit the steam stripper 500 as a steam stripper effluent 901.

In embodiments, the steam 699 is introduced into the steam stripper 500 at a ratio to the evaporator condensate introduced into the steam stripper 500. In embodiments, the ratio is from about 0.10 lbs. steam 699 to about 0.35 lbs. steam 699 per 1.0 lbs. evaporator condensate, alternatively, alternatively, about 0.17 lbs. steam 699 per about 1.0 lbs. evaporator condensate.

In embodiments, the steam 699 introduced into the steam stripper 500 will elevate the internal temperature of the steam stripper 500 to about 125° F., alternatively, to about 150° F., alternatively, to about 175° F., alternatively, to about 200° F., alternatively, to about 210° F.

In embodiment, the internal pressure of the steam stripper 500 is elevated to a pressure of from about 2 p.s.i. to about 7 p.s.i., alternatively, about 3 p.s.i.

In embodiments, the operation of the steam stripper 500 as previously disclosed herein may be effective to separate at least a portion of the ammonia comprising the evaporator condensate 501 therefrom. As previously described, the ammonia comprising one or more of the fluids or gases disclosed herein may be free or may be chemically bound. In embodiments, the operation of the steam stripper 500 as previously disclosed herein may be effective to separate that portion of the ammonia which is free, but ineffective to separate that portion of the ammonia which is chemically bound.

In embodiments, separating the bound ammonia from the evaporator condensate 501 may comprise elevating the pH of evaporator condensate 501. Elevating the pH of the evaporator condensate 501 may be effective in separating the chemically bound ammonia from the evaporator condensate 501. In such embodiments, elevating the pH may be accomplished by adding a first basic composition 503 to the evaporator condensate stream 501. In this embodiment the first basic composition 503 comprises sodium hydroxide (NaOH). In embodiments, the pH of the evaporator condensate is raised to about 10.0, alternatively, to about 10.5, alternatively, to about 11.0, alternatively, to about 11.5, alternatively, to about 12.0. Prior to the addition of the first basis composition 503, the pH of the evaporator condensate may be in the range of from about 4.5 to about 9.5.

Not seeking to be bound by theory, the introduction of sodium hydroxide (NaOH) may free the chemically bound ammonia, as demonstrated with respect to ammonia bound as ammonium acetate (NH₄CH₃COO) in Equation (V) and with respect to ammonia bound as ammonium sulfite ((NH₄)₂SO₃) in Equation (VI):

NH₄CH₃COO+NaOH→NH₃(g)+NaCH₃COO+H₂O Equation (V)

(NH₄)₂SO₃+2NaOH→2NH₃(g)+Na₂SO₃+2H₂O Equation (VI)

Similarly, ammonia may be released from other organic or inorganic compounds to which it is chemically bound.

In embodiments, the operation of the steam stripper 500 as previously disclosed herein may be effective to separate at least 90%, alternatively, at least 95%, alternatively, at least 99%, alternatively, at least 99.9%, alternatively, 100%. As previously explained, the ammonia separated from the evaporator condensate may be introduced into the cooking liquor generation system 200 as the regenerated ammonia stream 202 and utilized to regenerate the cooking liquor 102.

### Burning Waste Fuel/Generating Steam

Returning to FIG. 1, the ammonia loss control process 10 comprises generating steam 699. As previously discussed, in the embodiment of FIG. 1 the dilute spent cooking liquor 401 is concentrated in an evaporator 400 to yield the liquid evaporator effluent 501 and concentrated spent cooking liquor 601. In this embodiment, the concentrated spent cooking liquor 601 is introduced into a waste-fuel boiler 600. As previously disclosed, the concentrated spent cooking liquor 601 may comprise some portion of dissolved material, a non-limiting example of which is liquidified and/or suspended organic and inorganic matter which was washed out of the wood pulp 301 in the pulp washer 300. In this embodiment, the concentrated spent cooking liquor 601 is combustible.

In embodiments, waste fuel 602 is introduced into the furnace of a waste-fuel boiler 600. Non-limiting examples of such waste fuel 602 includes bark, sawdust, wood particulate matter, and the like. As will be understood by those of skill in the art, such waste fuel 602 may comprise the remnants of one or more steps of the ammonia loss control process 10 or other associated processes. For example, the bark, sawdust, or wood particulate matter may be remnants of processes such as logging, de-barking, milling, chipping, spent cooking liquor, and the like. In an alternative embodiment, waste fuel may be introduced into any suitable boiler, furnace, reactor, or the like in which the waste fuel may be combusted.

In the embodiment of FIG. 1, the heat from the combustion of the waste fuel 602 and the concentrated spent cooking liquor 601 is transferred to water in the waste-fuel boiler 600. As heat is transferred to the water, steam 699 is generated within the waste-fuel boiler 600. As previously discussed, in this embodiment steam 699 from the waste-fuel boiler 600 is utilized to provide heat to other components of the ammonia loss control process 10. As shown in FIG. 1, steam 699 is introduced into the digester 100 and into the steam stripper 500. In alternative embodiments, steam generated within a waste-fuel boiler such as waste-fuel boiler 600 may provide heat or pressure to any one or more of a digester such as digester 100, a steam stripper such as steam stripper 500, an evaporator such as evaporator 400 or a component of an ammonia loss control process similar to ammonia loss control process 10.

### Flue Gas

In the embodiment of FIG. 1, the combustion of the concentrated spent cooking liquor and the waste fuel in the waste-fuel boiler 600 yields a flue gas 701 which is emitted from the waste-fuel boiler 600. Alternatively, combustion in any such boiler, furnace, reactor, or the like may produce a flue gas. The flue gas may comprise sulfur dioxide (SO₂) and gaseous nitrogen (N₂) as demonstrated in Equation (VII).

(NH₄)₂SO₃+O₂→N₂(g)+SO₂(g)+H₂O(g) Equation (VII)

As will be understood by those of skill in the art, the production of sulfur dioxide (SO₂) is problematic. Sulfur dioxide (SO₂) is strictly regulated and must be managed.

Removing Sulfur Dioxide from Flue Gas

In embodiments, a sulfur-containing compound is removed from the flue gas 701, the concentrated spent cooking liquor 601, or both. In embodiments, removing the sulfur-containing compounds comprises contacting the flue gas 701, the concentrated spent cooking liquor 601, or both with magnesium oxide (MgO) 603, whereupon contact a reaction will occur between the sulfur-containing compound and the magnesium oxide (MgO) 603. Such a reaction may yield a solid, inert reaction product.

In the embodiment of FIG. 1, the ammonia loss control process 10 comprises introducing the magnesium oxide (MgO) 603 into the spent cooking liquor 601 prior to the introduction of the concentrated spent cooking liquor 601 into the waste-fuel boiler 600. Not seeking to be bound by any particular theory, the magnesium oxide (MgO) 603 may chemically react with the ammonium sulfite ((NH₄)₂SO₃) present in the concentrated spent cooking liquor, as demonstrated in Equation (VIII), thereby limiting the production of sulfur dioxide (SO₂).

(NH₄)₂SO₃+MgO→MgSO₄+NH₄⁺ Equation (VIII)

Still not seeking to be bound by any particular theory, the magnesium oxide (MgO) 603 may chemically react with the sulfur dioxide (SO₂) present in the flue gas, as demonstrated in Equation (IX).

2SO₂+2MgO+O₂→2MgSO₄ Equation (IX)

In either situation, the reaction of the magnesium oxide (MgO) with either the ammonium sulfite ((NH₄)₂SO₃) or the sulfur dioxide (SO₂) yields magnesium sulfate (MgSO₄) and limits the occurrence of sulfur dioxide (SO₂) within the flue gas 701.

### Disposing of Magnesium Sulfate

In embodiments, the ammonia loss control process 10 comprises removing the magnesium sulfate (MgSO₄) from the waste-fuel boiler 600 as solid particulate matter (for example, ash). The magnesium sulfate (MgSO₄) may be introduced into a water bath (for example, a pond) and allowed to settle. After the magnesium sulfate (MgSO₄) has settled, the water of that bath may be decanted, leaving behind solid, particulate matter comprising magnesium sulfate (MgSO₄). The magnesium sulfate (MgSO₄) produced via either of the foregoing reactions is chemically inert and, as such, poses no risk of further chemical reaction. Thus, the magnesium sulfate (MgSO₄) may be removed. The magnesium sulfate (MgSO₄) may be placed in a land-fill for disposal. Alternatively, the magnesium sulfate (MgSO₄) may be employed in a beneficial process. The water decanted from the water bath may be introduced into a water treatment system as will be described in greater detail herein.

### Scrubbing the Flue Gas

In embodiments, the ammonia loss control process 10 comprises contacting a second basic composition 702 with the flue gas 701. Not seeking to be bound by theory, the second basic composition 702 will chemically react with any sulfur dioxide (SO₂) remaining within the flue gas 701. In the embodiment of FIG. 1, the second basic composition 702 and the flue gas 701 are introduced into a flue-gas scrubber 700. As will be understood by those of skill in the art, a scrubber such as flue-gas scrubber 700 may be used to remove or neutralize exhaust gases of combustion which may be harmful to the environment by providing a setting in which a target compound (e.g., sulfur dioxide (SO₂) will come into contact and react with a scrubbing solution (e.g., the second basic composition 702).

In various embodiments, the second basic composition 702 comprises magnesium hydroxide (Mg(OH)₂), sodium hydroxide (NaOH), sodium carbonate (Na₂CO₃), calcium hydroxide (Ca(OH)₂), calcium carbonate (CaCO₃), or combinations thereof. Not to be bound by theory, in embodiments where the second basic composition 702 comprises magnesium hydroxide (Mg(OH)₂), the resulting chemical reaction will yield magnesium sulfite (MgSO₃) as shown in Equation (X).

Mg(OH)₂+SO₂→MgSO₃+H₂O

Not to be bound by theory, in embodiments where the second basic composition 702 comprises sodium hydroxide (NaOH) or sodium carbonate (Na₂CO₃), the resulting chemical reaction with sulfur dioxide (SO₂) will yield sodium sulfite (Na₂SO₃), as shown in Equations (XI) and (XII).

NaOH+SO₂→Na₂SO₃+H₂O Equation (XI)

Na₂CO₃+SO₂→Na₂SO₃+CO₂ Equation (XII)

Not to be bound by theory, in embodiments where the second basic composition 702 comprises calcium hydroxide (Ca(OH)₂) or calcium carbonate (CaCO₃), the resulting chemical reaction with sulfur dioxide (SO₂) will yield calcium sulfite (Ca₂SO₃), as shown in Equations (XIII) and (XIV).

Ca(OH)₂+SO₂→CaSO₃+H₂O Equation (XIII)

CaCO₃+SO₂→CaSO₃+CO₂ Equation (XIV)

In an embodiment, some or all forms of sulfites present may be further oxidized to sulfates by contact with oxygen to form the most stable and/or inert compound.

Conventionally, the sulfur dioxide (SO₂) resulting from combustion of waste fuels and concentrated spent cooking liquor was captured by contacting (e.g., “scrubbing”) the flue gas with ammonia. The ammonia loss control process 10 eliminates the need for ammonia scrubbing of residual sulfur dioxide (SO₂) in the flue gas by utilizing various basic compositions to scrub the residual sulfur dioxide (SO₂) from the flue gas. Further, in the ammonia loss control process 10 the second basic composition 702 may be added in excess so as to provide alkalinity to an effluent treatment system 900, which will be discussed in greater detail herein.

In embodiments, the ammonia loss control process 10 comprises making paper from washed pulp 801. In the embodiment of FIG. 1, washed pulp 801 from the pulp washer 300 is fed into a paper machine 800. As will be understood by those of skill in the art, the operation of the paper machine 800 comprises slurrying the washed pulp 801 (that is, suspending the pulp in water to form a slurry). In the paper machine 800, the pulp slurry spills into a headbox section where the fibers align across the width of a wire or screen and water is removed, leaving behind a web of pulp which will be further processed to yield paper. As disclosed herein, washing the pulp removes at least a portion of the ammonia; however, in embodiments at least a portion of the ammonia will remain in the washed pulp 801. In the embodiment of FIG. 1, slurrying the pulp removes at least a portion of the ammonia remaining in the washed pulp. Thus, a paper machine effluent 903 (which comprises the water in which the pulp was slurried) will comprise ammonia. Because most of the ammonia will have been removed from the washed pulp 801 and because a generally large quantity of water is utilized to slurry the pulp, the ammonia comprising the paper machine effluent will be relatively dilute.

### Effluent Treatment-Nitrification/Denitrification

In embodiments, the ammonia loss control process 10 comprises treating one or more of the effluents of the ammonia loss control process 10. In the embodiment of FIG. 1, ammonia is removed from a steam stripper effluent 901, a flue-gas scrubber effluent 902, and a paper machine effluent 903 in the effluent treatment system 900. In embodiments, the effluent treatment system 900 is configured to remove ammonia from a liquid effluent. Alternatively, at least one of the steam stripper effluent 901, the flue-gas scrubber effluent, or the paper machine effluent may be introduced into the effluent treatment system.

In embodiments, the effluent treatment system 900 comprises a biological treatment system. In such embodiments, the biological treatment system may comprise one or more microorganisms which will metabolize ammonia (nitrification). As used herein, the term “metabolize” means subjecting a chemical species or compound to a series of chemical reactions, wherein the chemical species or compound is converted to another chemical species or compound. As used herein, “nitrification” refers to the biological oxidation of ammonia by nitrifying bacteria to nitrite and finally to nitrate. As used herein, “denitrification” refers to the use of carbon from soluble and insoluble organics (known as biochemical oxygen demand (BOD)) to convert nitrate to nitrogen gas.

Nitrosomonas, is genus comprising of rod shaped chemoautotrophic bacteria. Nitrosomonas oxidizes ammonia (NH₃) into nitrite (NO₂) as a part of its metabolic processes. Nitrosomonas are important in the nitrogen cycle by increasing the availability of nitrogen to plants while limiting carbon dioxide fixation. Members of Nitrosomonas generally have an optimum pH of 6.0-9.0 and an optimum temperature range of 20 to 30° C.

Nitrobacter is genus of mostly rod-shaped, gram-negative, and chemoautotrophic bacteria. Nitrobacter is known to those of skill in the art to metabolize various nitrogen species. Specifically, Nitrobacter plays an important role in the nitrogen cycle by oxidizing nitrite (NO₂) into nitrate (NO₃⁻). Nitrobacter use energy from the oxidation of nitrite ions, NO₂⁻, into nitrate ions, NO₃⁻ to fulfill their carbon requirements. Members of Nitrobacter generally have an optimum pH between 7.3 and 7.5, and will die in temperatures exceeding 49° C. or below 0° C.

In an embodiment, denitrification is accomplished by contacting a BOD with a nitrate such that nitrogen gas may be released. Denitrification requires BOD as a carbon source, which is followed by nitrification with a high internal recirculation rate from nitrification to denitrification.

In the embodiment of FIG. 1, the biological treatment system comprises a member of the genus Nitrosomonas and a member of the genus Nitrobacter. Not seeking to be bound by theory, nitrate (NO₃) produced in the nitrification cell 1000 may use BOD as carbon source to convert nitrate (NO₃) to nitrogen gas (N₂) 910 in a denitrification cell 900. Ammonia remaining in any effluent stream from the mill production process will pass through the denitrification cell 900 to be converted to nitrite (NO₂⁻) by Nitrosomonas and then to nitrate (NO₃) by Nitrobacter in the nitrification cell 1000. Nitrates (NO₃) produced in the nitrification cell 1000 are returned to the denitrification cell 900 by recycle flow 905 in order to remove nitrate (NO₃) from the process. Not to be bound by theory, some nitrates may not be captured in the recycle thereby passing to the existing effluent treatment system. These nitrates may be reduced to nitrogen gas by providing an ammonia free source of BOD 1002 to effluent treatment system 1100 that may be routed around the ammonia reduction system for this purpose. Oxygen and pH-adjusting compounds may be provided to the process in proportion to system loads and to achieve desired pH levels.

In this embodiment, the biological treatment system will remove at least about 92% of the ammonia entering the system, alternatively, at least 90%, alternatively, at least 85%, alternatively, at least 80%.

Once nitrification/denitrification has been accomplished, the biological treatment system effluent stream 1001 may be passed to the existing effluent treatment system 1100 for removal of BOD and suspended solids as required by regulatory permits.

### Process Output

In the embodiment of FIG. 1, the ammonia loss control process 10 comprises emitting a process effluent 1101. The process effluent 1101 may be substantially free of ammonia. In embodiments, the process effluent 1101 comprises less than 100 p.p.m. of ammonia, alternatively, less than 50 p.p.m. of ammonia, alternatively, less than 10 p.p.m. of ammonia.

### Process Efficiency/Manipulation of the Process

In the embodiment of FIG. 1, from about 50% to about 98% of the ammonia which enters the ammonia loss control process 10 is recovered and/or converted to nitrogen gas (N₂). It is specifically contemplated that, in similar ammonia loss control processes, elements of the ammonia loss control process 10 may be configured so as to maximize the efficiency of such a process. It is specifically contemplated that the efficiency of each of the steps or operations of such alternative processes may be manipulated dependent upon a plurality of factors. In alternative embodiments, a process may be configured to recover ammonia from one or more effluent streams comprising ammonia by one or more of the process elements disclosed herein. As will be appreciated by one of ordinary skill in the art, recovering ammonia from an effluent stream comprises an associated cost. As such, one of skill in the art will appreciate that an economically efficient process may be attained by balancing the costs of recovering ammonia from an effluent stream against the cost of inputting additional ammonia and/or the cost of treating process effluents to achieve regulatory levels.

As will be appreciated by one of skill in the art, operating costs associated with various ammonia recovery processes may be largely dependent on the costs of various inputs (e.g., chemicals employed at one or more steps in a process) as well as the relative value attained (e.g., the value of ammonia recaptured). Chemicals continually vary as to pricing and as to cost relative to one another. Further, additional operating costs may include increased steam and/or electrical usage, such costs also being continually variable.

In an embodiment, it is specifically contemplated that a computer model employing actual operating data, current costs and/or pricing information, individual system efficiencies, and desired ammonia reduction efficiency may be used to determine the most practical and/or efficient operation of such a process.

For example, condensate may be captured from the digester and returned to the liquor making process substantially as is. Since the majority of ammonia in this stream may occur as free ammonia, it may be immediately reusable as a cooking liquor make-up. Ammonia returned to the process may be as high as 5-6% of that used in the process. The reduction of total ammonia losses may be approximately 15%. At current prices, this equates to a value of approximately $400/day. Steam stripping the digester condensate to remove more ammonia may increase the return value (e.g., about $100 at current prices), but at a cost of employing the steam stripping (e.g., about $3000/day at current prices).

Also, for example, additional or increased pulp washing cycles may be employed to remove more ammonia from pulp. However, increased washing may require that the wash water be subjected to increased evaporation. More evaporation may require additional capital expenditures (e.g., operating costs may be increased by the additional steam required to evaporate the increase in wash water). Increased washing may decrease either ammonia and/or BOD loading on the mill effluent treatment system thereby reducing operating costs. Increased evaporation may yield proportionally more (as much as 150%) condensates to be steam stripped (e.g., as by steam stripper 500). Steam stripping costs may include capital for the steam stripper and related equipment as well as operating costs for steam and electrical power. Ammonia returned to the process could be 6-14% of that applied and a reduction of total ammonia losses of approximately 45%. In an embodiment, optimization of steam stripper steam usage may be accomplished by incorporating the steam stripper with an evaporator. At current prices, increased evaporator steam might cost approximately $1200/day. Elevation of the pH may be employed to attain maximum steam stripping (e.g., as by the addition of a caustic soda). At current prices, this would be an additional cost of approximately $2500/day. At current prices, the value of the captured ammonia would be approximately $1000/day.

Also, for example, the waste-fuel-boiler scrubber may be operated using other base elements. Ammonia has historically been the least expensive of the base elements used for scrubbing sulfur dioxide. At current prices, sodium hydroxide (NaOH) costs approximately 56% more and magnesium oxide (MgO) costs approximately 265% more. For example, at current prices, replacing ammonia with sodium hydroxide (NaOH) as a scrubbing material in the waste-fuel-boiler scrubber might increase cost of this operation by approximately 450% (approximately $5000/day).

Also, for example, the cost of operating a biological treatment system may be largely dependent upon the degree to which that system is loaded. Thus, where ammonia is captured or removed by one or more of the upstream processes, the cost of operating the effluent treatment system may be substantially reduced. Alkalinity may be naturally produced from removal of waste-fuel-boiler ash. If loading is managed such that this natural alkalinity is not totally consumed, there may be little or no need for increasing the alkalinity (e.g., as by the addition of sodium bicarbonate). At current prices, costs of maintaining alkalinity may range from $3000 per day (e.g., for a higher ammonia load) to near zero (e.g., for a lower ammonia load). Likewise power needed to supply oxygen may cost approximately $2400/day (e.g., for a higher ammonia load) to approximately $1700/day (e.g., for a lower ammonia load).

In an alternative embodiment, a steam stripper such as steam stripper 500 may be employed to recover ammonia from an effluent stream, as is disclosed herein. For example, ammonia comprising a flue-gas scrubber effluent such as flue-gas scrubber effluent 902, a paper machine effluent such as paper machine effluent 903, or both may be separated in a steam stripper as discussed above. By removing ammonia via the operation of such a steam stripper, additional ammonia might be recovered for reuse in such a process. Further, reliance on an effluent treatment system such as effluent treatment system 900 might be decreased or alleviated. As will be appreciated by one of skill in the art, variability in costs of inputs, changes in regulatory levels of effluent streams, and various other factors will bear on the overall economic efficiency of such a process. One of skill in the art will appreciate that the processes and systems disclosed herein may be configured to achieve maximum efficiency by balancing the costs associated with recovery of ammonia against the costs of additional ammonia inputs and/or treating process effluents to meet regulatory levels.

### CONCLUSION

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k* (Rᵤ−R₁), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural or other details supplementary to the disclosure.

1. A method of offsetting losses of ammonia from a pulping mill comprising:
cooking a lignocellulosic material in a cooking liquor, wherein cooking in the cooking liquor separates the lignocellulosic material into a pulp;
capturing a vapor of the cooking liquor;
condensing the vapor of the cooking liquor to yield a spent cooking liquor condensate;
washing the pulp in a wash liquid, wherein washing the pulp removes at least a portion of the spent cooking liquor from the pulp;
capturing the wash liquid;
removing ammonia from the wash liquid to yield a regenerated ammonia;
regenerating the cooking liquor from the spent cooking liquor condensate and the regenerated ammonia;
combusting a waste material and a concentrated spent cooking liquor, wherein combusting the waste material and the concentrated spent cooking liquor yields a flue gas and heat;
transferring the heat from combusting the waste material and the concentrated spent cooking liquor to water to generate steam;
removing a sulfur-containing compound from the flue gas; and
introducing an effluent stream into an effluent treatment system, wherein introduction of the effluent stream into the effluent system will remove ammonia from the effluent stream.

2. The method of claim 1, wherein removing ammonia from the wash liquid to yield a regenerated ammonia comprises:
evaporating a portion of the wash liquid to yield the concentrated spent cooking liquor and a vaporous mixture of water and ammonia;
condensing the vaporous mixture of water and ammonia to yield an evaporator condensate;
separating the ammonia from the evaporator condensate to yield a regenerated ammonia.

3. The method of claim 2, wherein separating the ammonia from the evaporator condensate comprises raising the pH of the evaporator condensate.

4. The method of claim 3, wherein the pH of the evaporator condensate is raised to at least about 10.0.

5. The method of claim 2, wherein separating the ammonia from the evaporator condensate comprises distilling the evaporator condensate.

6. The method of claim 5, wherein distilling the evaporator condensate is performed in a packed column stripper.

7. The method of claim 1, further comprising contacting magnesium oxide with the concentrated spent cooking liquor.

8. The method of claim 1, wherein removing a sulfur-containing compound from the flue gas comprises contacting a base compound with the flue gas, wherein the basic compound comprises a pH of at least 10.0.

9. The method of claim 8, wherein the basic compound comprises magnesium hydroxide, sodium hydroxide, sodium carbonate, or combinations thereof.

10. The method of claim 1, further comprising introducing the pulp into a paper machine, wherein the pulp is introduced into the paper machine after the pulp has been washed.

11. A method of recovering ammonia from a pulping process comprising:
washing a pulp in a wash liquid;
capturing the wash liquid;
evaporating a portion of the wash liquid to yield a vaporous mixture of water and ammonia;
condensing the vaporous mixture of water and ammonia to yield an evaporator condensate;
raising the pH of the evaporator condensate; and
separating the ammonia from the evaporator condensate to yield a regenerated ammonia.

12. The method of claim 11, further comprising introducing the wash liquid into an evaporator.

13. The method of claim 12, wherein the temperature within at least a portion of the evaporator is at least 120° F.

14. The method of claim 11, further comprising introducing the evaporator condensate into packed column stripper.

15. The method of claim 11, wherein the pH of the evaporator condensate is raised to at least about 10.0.

16. The method of claim 15, wherein the pH of the evaporator condensate is raised to at least about 10.5.

17. The method of claim 16, wherein the pH of the evaporator condensate is raised to at least about 11.0.

18. A method of controlling the occurrence of a sulfur-containing compound in a waste-fuel boiler flue gas comprising:
introducing a waste material and a concentrated spent cooking liquor into the waste-fuel boiler;
contacting magnesium oxide with the concentrated spent cooking liquor;
combusting the waste material and the concentrated spent cooking liquor, wherein combusting the waste material and the concentrated spent cooking liquor yields the flue gas; and
contacting a base compound with the flue gas.

19. The method of claim 18, wherein the base compound does not comprise ammonium hydroxide.

20. The method of claim 18, wherein the base compound comprises magnesium hydroxide, sodium hydroxide, sodium carbonate, calcium hydroxide, calcium carbonate or combinations thereof

21. The method of claim 18, further comprising introducing the flue gas into a scrubber, wherein contacting the base compound with the flue gas occurs within the scrubber.
